(19) United States
(12) Patent Application Publication
(10) Pub. No.: US 2004/0002869 A1
(43) Pub. Date: Jan. 1, 2004

(54) Method and system for storing items using a portable closet

(76) Inventor: Erik T. Ekstein, New York, NY (US)

Correspondence Address: COUDERT BROTHERS, ATTN: LEWIS REFF, 1114 AVENUE OF THE AMERICAS, NEW YORK, NY, 10036, US

(21) Appl. No.: 10/186,595

(22) Filed: Jun. 28, 2002

(51) Int. Cl. G06F 17/60

(52) U.S. Cl. 705/1; 705/26

(57) ABSTRACT

A system and method is given for storing by a service provider in a remote storage facility a portable closet containing one or more personal or business items of a customer. In one embodiment, the service provider delivers a customer configurable empty portable closet to the customer's premises. The portable closet is made to be wheeled through a standard sized apartment door. The customer packs the closet with one or more items. The service provider then picks up the partially or completely full portable closet and stores the portable closet in a remote storage facility. Upon customer request the portable closet is returned to the customer by the service provider. The contents of the portable closet are then modified by the customer and the closet then picked up and returned to storage by the service provider. The process of return to the customer, pick-up, and re-storage may be repeated to provide a virtual closet to the customer.

### CROSS REFERENCES

This application is co-pending with and incorporates by reference in its entirety U.S. application Ser. No. ______, titled “Movable Storage Container” by Erik T. Ekstein, filed Jun. 28, 2002.

### FIELD OF THE INVENTION

The invention relates generally to the field of storage, and in particular to a system and method for storing personal or business items using a portable closet.

### BACKGROUND OF THE INVENTION

In today's high density urban environments, e.g., New York City, San Francisco, and other cities where living space is limited, personal items, e.g., books, clothes, toys, reduces the available space a person needs to live in. However, one of the benefits of living in a modern society is the ability to obtain and accumulate personal property.

In the city in order not to decrease the living space, but to have many possessions, traditionally, a space in a remote storage facility is rented. The person must either pack and move the items to be stored to the remote storage facility or hire someone to do it for them. Unfortunately, the cost of hiring someone to pack and move is significantly more expensive than self-packing and only hiring a mover.

One prior art system offers a pickup and delivery system (PUD), which delivers a medium sized container, e.g., large enough to store furniture, to your driveway, which you pack yourself. When you're finished, you call the company for a pickup, and they will then transport your filled container to their remote storage facility. When you wish to retrieve your items, you have the option of going to the remote storage facility or having the container delivered back to you. Some of the disadvantages are: for an urban environment, e.g., New York city, finding a good place to put the container, unlike the sub-urban or rural areas, may be difficult; and the container is on the outside, so filling the container in bad weather, e.g., rain, may be a problem.

An additional disadvantage is that, once the items are stored, there is a significant disadvantage in accessing some of the items. Unlike packing, e.g., a clothes collection, in a box and putting it in the closet at home, there is no easy access to the remote storage, should there be a need to, for example, use one of those stored clothes. Typically, travel to the remote storage facility, access to the rented storage space, sorting through the normally unordered boxes, and return travel home are required. Hence, while remote storage has allowed keeping more possessions while not reducing the living space, the stored items become inconvenient to access and use.

Thus there is a need for a storage container and process in an urban environment, which provides for the convenient packing of a person's personal possessions in that person's living or working space and convenient access when the person wants to retrieve one or more items from storage.

### SUMMARY OF THE INVENTION

The present invention provides a system and method for storing by a service provider in a remote storage facility a portable closet containing one or more personal or business items of a customer. The portable closet functions as a virtual closet for the customer, in which items may be stored without reducing the available living or working space of the customer.

In one preferred embodiment, the service provider delivers a customer configurable empty portable closet to the customer's premises. The portable closet is made to be wheeled through a standard sized apartment door. The customer packs the closet with one or more items. The service provider then picks up the partially or completely full portable closet and stores the portable closet in a remote storage facility. Upon customer request the portable closet is returned to the customer by the service provider. The contents of the portable closet are then modified by the customer and the closet then picked up and returned to storage by the service provider. The process of return to the customer, pick-up, and re-storage may be repeated to provide the virtual closet to the customer.

While use of such a portable closet in the preferred embodiment is primarily for apartments or condominiums in a dense urban environment, e.g., New York City, the portable closet may be used in other environments, such as suburban apartments, condominiums, or even residential homes or anywhere where there may be a shortage of living space.

An embodiment of the present invention provides a method for storing by a service provider, in a remote storage facility, a portable closet, including a plurality of items of a customer. First, the service provider delivers an empty portable closet configured to fit through a standard doorway entrance to a customer's site, where the portable closet is non-collapsible and includes a plurality of wheels attached to the portable closet. Next, the service provider retrieves for storage a packed portable closet from the customer's site, where the packed portable closet is the empty portable closet packed by the customer with the plurality of items. And the first packed portable closet is stored in the remote storage facility by the service provider.

Another embodiment of the present invention provides a method for storing by a service provider, in a remote storage facility, a portable container, including a plurality of items of a customer. First, the service provider delivers an empty portable container configured to fit through a standard doorway entrance of a customer's site, where the portable container includes wheels for portability and non-collapsible walls. Next the service provider retrieves for storage a packed portable container from the customer's site, where the packed portable container is the empty portable container packed by the customer with the plurality of items. The packed portable container is stored in a remote storage facility by the service provider. Next, responsive to the customer requesting access to the packed portable container, the service provider delivers from the remote storage facility the packed portable container to the customer's site. And lastly, the service provider retrieves for storage the packed portable container having at least one of the plurality of items removed by the customer.

Yet another embodiment of the present invention provides a method for storing a plurality of items of a customer in a portable closet. The customer is at a first computer placing an order related to the portable closet to a service provider at a second computer via a communications network. First the first computer configures an empty portable closet. Next, deliver of the configured empty portable closet to inside a customer's site, using a standard doorway entrance, is scheduled. And lastly, a packed portable closet from inside the customer's site is scheduled for retrieval, where the packed portable closet is the configured empty portable closet packed by the customer with the plurality of items.

Another embodiment of the present invention provides a method for storing a portable closet by a service provider in a remote storage facility, using a computer system. First, the computer receives an order by the customer for the portable closet, where the order includes configuration information. The portable closet includes a clothes hanger bar, wheels, and non-collapsible walls. Next, an identifier associated with the portable closet is assigned. The portable closet is labeled with at least the identifier. Responsive to a request for delivery of the portable closet to the customer's premises, graphical information is sent for a deliver calendar which includes available and unavailable times for delivery of the portable closet. After the customer selects an available time for delivery from the deliver calendar, the identifier is added to a delivery queue, where the delivery queue is stored in memory. The portable closet is delivered to the customer's premises at the scheduled time. And responsive to a request for pickup of the portable closet, the portable closet is retrieved and stored in the remote storage facility.

An embodiment of the present invention provides a method, using a computer, for storing by a service provider, in a remote storage facility, a plurality of portable closets, where a portable closet of the plurality of portable closets includes an item of a customer. First, the portable closet is received at the remote storage facility. Next, an empty storage location element is found in a storage array using a computer search. The storage array, includes a three dimensional array having elements for empty and occupied storage locations in the remote storage facility for the plurality of portable closets, where the elements are stored in a memory of the computer. Next, an identifier associated with the portable closet is assigned to the found empty storage location element in the storage array. The portable closet is stored in a storage location associated with the found empty storage location element.

A further embodiment of the present invention provides a system for storing a plurality of portable closets in a storage facility including: a plurality of structures, where each structure of the plurality of structures is positioned generally perpendicular to the floor of the storage facility and parallel to at least one other structure of the plurality of structures; a track in the storage facility for moving the plurality of structures, where each structure of the plurality of structures is mounted on the track via at least one wheel; and a plurality of storage locations in each structure of the plurality of structures, where a storage location of the plurality of storage locations holds a portable storage closet of the plurality of portable closets.

These and other embodiments, features, aspects and advantages of the invention will become better understood with regard to the following description, appended claims and accompanying drawings.

### BRIEF DESCRIPTION OF THE DRAWINGS

FIG. 1 is a schematic showing the hardware components and their interconnections of an embodiment of the present invention.

FIG. 2 is a flowchart of the process used by the customer to order and schedule delivery of one or more portable closets from a service provider of an embodiment of the present invention.

FIG. 3 is a closet configuration window used by a customer to configure one or more portable closets of an embodiment of the present invention.

FIG. 4 is an example of a window summarizing a customer's order and for selecting a delivery/pickup/return of a portable closet.

FIG. 5 is an example of a window having a calendar and a time slot schedule of an embodiment of the present invention.

FIG. 6 is a flowchart of the process that is performed by the service provider in delivering, retrieving, and storing the portable closet of one embodiment of the present invention.

FIG. 7 is an example of a window of the daily deliveries (and/or pick-ups) of portable closets to (or from) customers.

FIG. 8 is an example of a window showing the route categories for the deliveries (and/or pick-ups) for a particular date.

FIG. 9 is an example of a delivery (and/or pick-up) queue window allowing for the input of the status of the delivery (and/or pick-up) of the portable closets to the customers for a given date.

FIG. 10 is an example of a window for selecting what action is to be performed on existing customer's portable closets by the service provider.

FIG. 11 is a framework mounted on tracks for holding a plurality of portable closets of one embodiment of the present invention.

FIG. 12 shows a plurality of frameworks like FIG. 11 of an embodiment of the present invention.

FIG. 13 is a flowchart of the process of storing a portable closet in the remote storage facility of an embodiment of the present invention.

FIG. 14 is a flowchart of the process for retrieving the portable closet from the remote storage facility of an embodiment of the present invention.

### DETAILED DESCRIPTION OF THE INVENTION

In the following description, numerous specific details are set forth to provide a more thorough description of the specific embodiments of the invention. It is apparent, however, to one skilled in the art, that the invention may be practiced without all the specific details given below. In other instances, well known features have not been described in detail so as not to obscure the invention.

The preferred embodiment of the present invention uses a movable storage container, i.e., “portable closet” as used herein, described in co-pending U.S. patent application Ser. No. ______, titled “Movable Storage Container” by Erik T. Ekstein, filed Jun. 28, 2002, which is herein incorporated by reference. Other embodiments of the present invention use a portable closet comprising non-collapsible, rigid walls, for example, wood or metal or plastic walls having a rigid frame, and wheels attached to bottom of the portable closet, and where the portable closet is of external dimensions that allow the portable closet to fit through a standard sized apartment doorway.

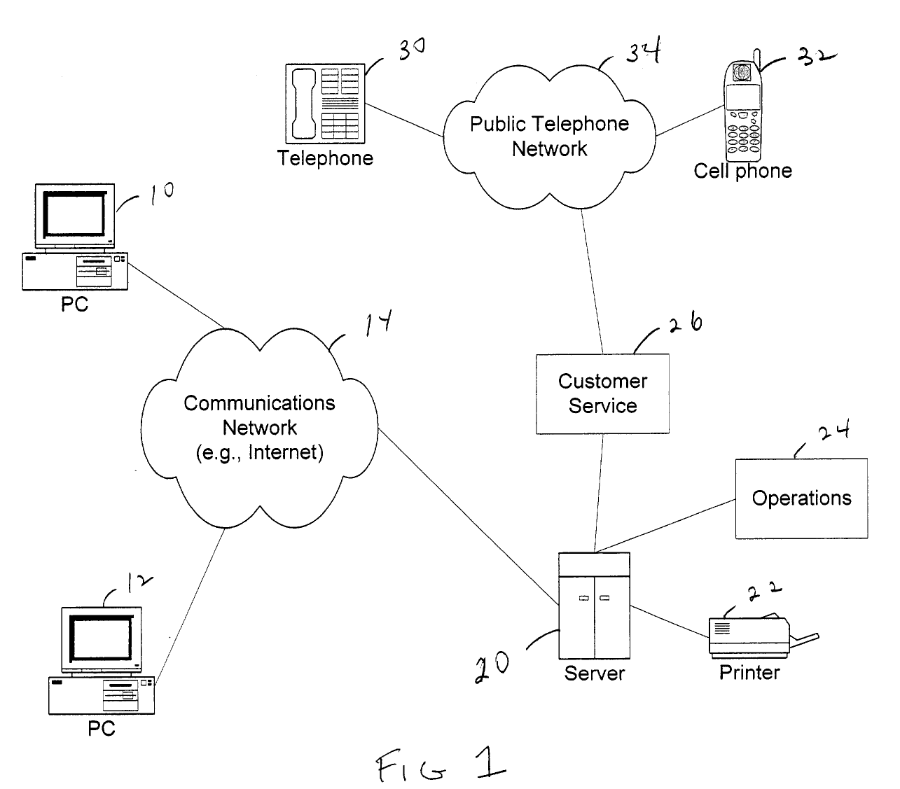

FIG. 1 is a schematic showing the hardware components and their interconnections of an embodiment of the present invention. The customers may use Personal Computers (PCs) 10 and 12 to order and schedule delivery of their portable closets from a service provider located at a remote storage facility. PCs 10 and 12 are connected via a communications network 14, e.g., the Internet, to service provider server 20. Server 20 is controlled by computers in the service provider's operations section 24. Server 20 executes the service providers software to control and monitor delivery and storage of the portable closets to and from the multiple customers. Server 20 is connected to printer 22 for printing items such as labels to be put on the portable closets. A label includes a unique identifier, e.g., closet number, identifying a specific portable closet. A customer service section 26 includes computers to enter customer order and scheduling information received by telephone from, for example, telephone 30 and cell phone 32 connected to telephones (not shown) in the customer service section 26 via public telephone network 34.

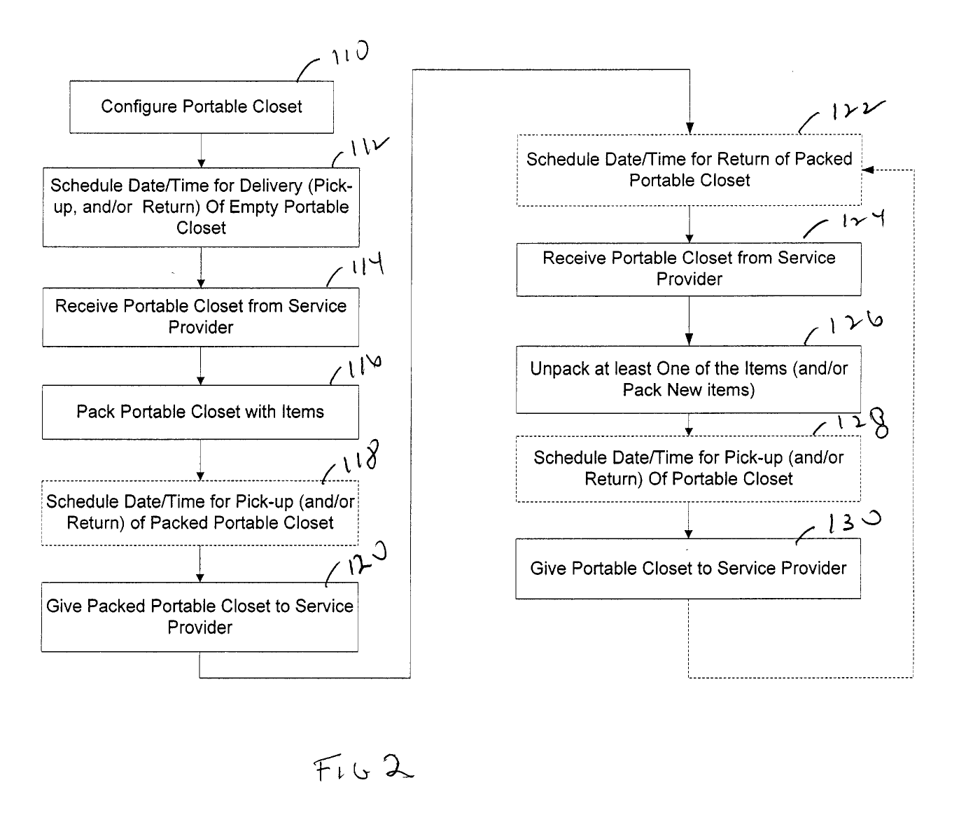

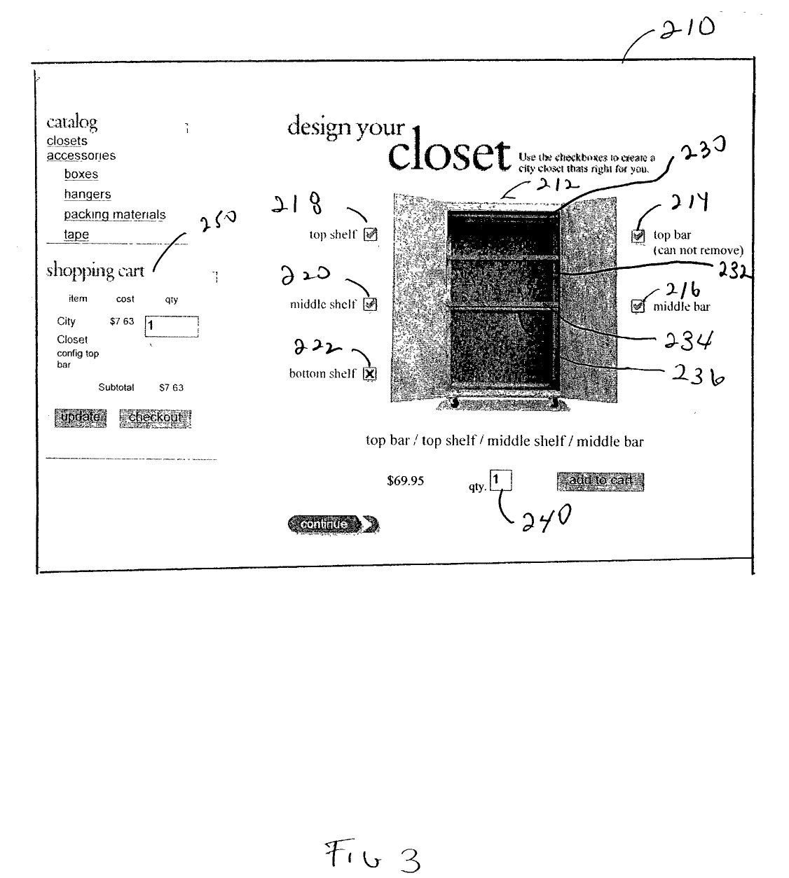

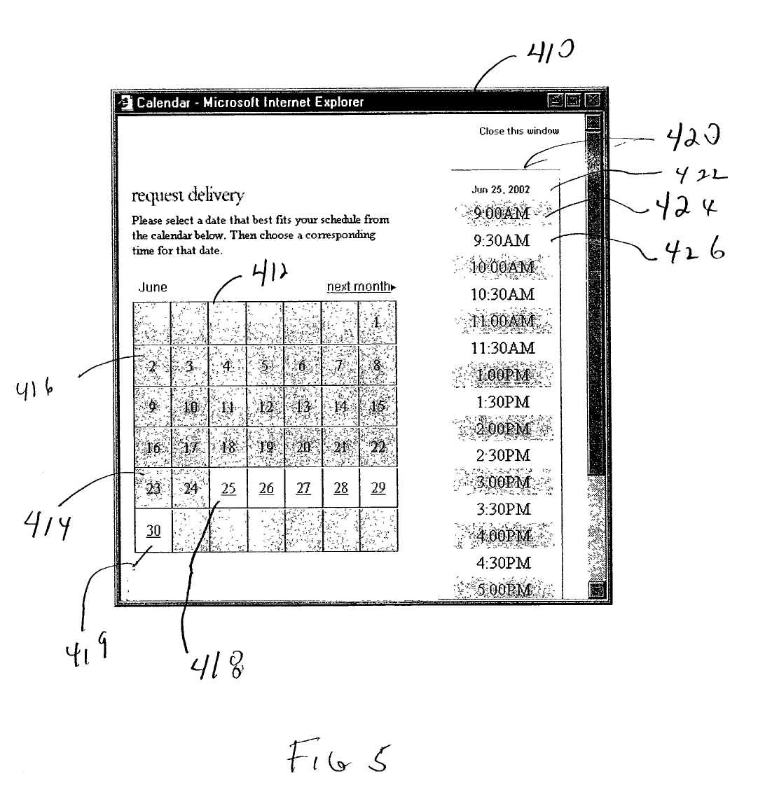

FIG. 2 is a flowchart of the process used by the customer to order and schedule delivery of one or more portable closets from a service provider of an embodiment of the present invention. At step 110, the customer configures a portable closet using, for example, the window 210 given in FIG. 3 displayed at, for example, customer PC 10. Each portable storage closet that the customer orders has a fixed number, e.g., two, of free return deliveries credits (free return deliveries of the portable closet) which must be used in a predetermined time period, e.g., one year. These fixed number of free return delivery credits per potable closet are summed to one accumulated number which may be redistributed over all the portable closets of the customer, rather than the portable closet the delivery credits were initially assigned to. At step 112, the customer chooses a date and time for delivery of an empty portable closet, using for example the calendar window 410 shown in FIG. 5. Optionally, the customer may schedule in advance, pickup of the portable closet, after it has been packed by the customer, and/or return of the packed storage closet from storage. At step 114, the customer receives the empty portable closet from the service provider in the customer's living or working space, for example, inside a customer's apartment. At step 116, the customer packs either directly or indirectly (i.e., the customer has someone do the packing) the portable closet with one or more items. At step 118 the customer schedules a date and time for pickup of the packed portable closet, if she has not already done so, (e.g., see calendar window 410 shown in FIG. 5). At step 120, upon arrival of the service provider at the scheduled time, the customer gives the packed portable closet to the service provider for storage.

The customer at step 122 schedules a date and time for return of the packed portable closet to her home or office (e.g., see calendar window 410 shown in FIG. 5). At step 124, the customer receives the portable closet from the service provider in her home or office at the scheduled return date and time. At step 126, the customer modifies the contents of the packed closet, for example, by unpacking at least one of the items or packing a new item or a combination thereof. At step 128, the customer schedules a date and time for pickup of the repacked portable closet (e.g., see calendar window 410 shown in FIG. 5). And optionally, may schedule in advance a date and the time for return of the portable closet (e.g., see calendar window 410 shown in FIG. 5). When the service provider arrives at the scheduled date and time for pickup, the customer gives the closet to the service provider (step 130). Steps 122 to 130 may be repeated, so that the portable storage closet is shuttled between the customer's premises and the service provider's remote storage facility, where typically each time the customer receives the portable closet, the customer modifies the contents of the portable closet.

FIG. 3 is a closet configuration window 210 used by a customer to configure one or more portable closets of an embodiment of the present invention. Window 210 is displayed, for example, on PC 10. A portable closet 212 is shown with multiple options for configuration of the interior of the portable closet. For example, a person may check a top shelf selection 218 (e.g., top shelf 232), a middle shelf selection 220 (e.g., middle shelf 234), a bottom shelf selection 222 (not shown) or any combination thereof, including selecting no shelves at all. A top bar selection 214 (e.g., top bar 230) and a middle bar selection 216 (e.g., middle bar 236) or any combination thereof, including selecting no bars at all, may also be selected. In one embodiment, when middle bar selection 216 is selected, the bottom shelf selection 222 cannot be chosen (shown by the “X” in the selection box 222). In an alternative embodiment, both a middle bar 216 and a bottom shelf 222 may be selected. In addition, a quantity selection 240 allows the customer to enter the number of portable closet's with the same configuration. The customer may also order other quantities of portable closets with different configurations. The shopping cart 250 lists the number of portable closets with a particular configuration.

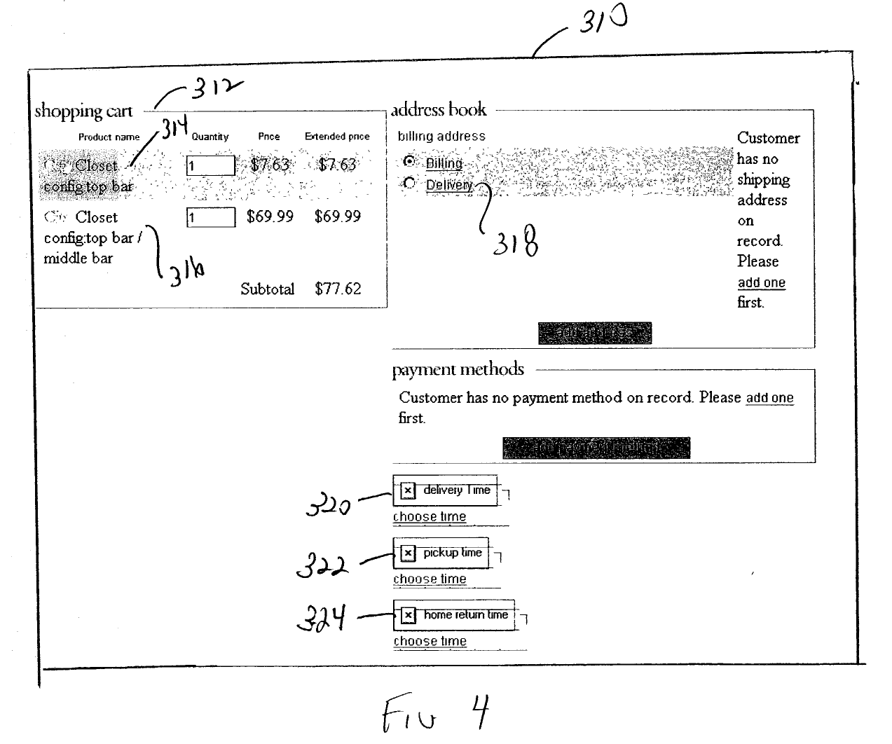

FIG. 4 is an example of a window 310 summarizing a customer's order and for selecting a delivery/pickup/return of a portable closet. Window 310 includes a shopping cart 312 which shows an order of one portable closet 314 configured with a top bar and another portable closet 316 with a top and a middle bar. Hyperlink 318 allows for entry of the customer's address for delivery of the portable closet. Selection 320 allows for scheduling of the delivery time of the empty portable closet to the customer's premises. Selection 322 allows for the scheduling of the pickup time of the packed portable closet from the customer's premises. And selection 324 allows for the scheduling of the home/office return time of the packed portable closet to the customer's premises from the remote storage facility. Selecting hyperlinks 320, 322, or 324 brings up a pop-up window 410 in FIG. 5.

FIG. 5 is an example of a window 410 having a calendar 412 and a time slot schedule 420 of an embodiment of the present invention. In calendar 412 the non-available dates are grayed-out (i.e., made non-selectable), for example, dates 414 (June 23) and 416 (June 2) and the available dates are not grayed-out and underlined, for example, dates 418 (June 25) and 419 (June 30). The underlined dates are hyperlinks which change the date above the time slot schedule 420. For example, selecting date 418 (June 25), brings up the time slot schedule 420 with date 422 (Jun. 25, 2002). In the time slot schedule 420 for date 418, the non-available time slots, e.g., 424, are grayed-out (i.e., made non-selectable). The available time slots, e.g., 426, are not grayed-out and selectable. After the time slot is selected, the date and time slot for the delivery/pickup/return of a portable closet as specified in FIG. 4 is sent to server 20 at the service provider.

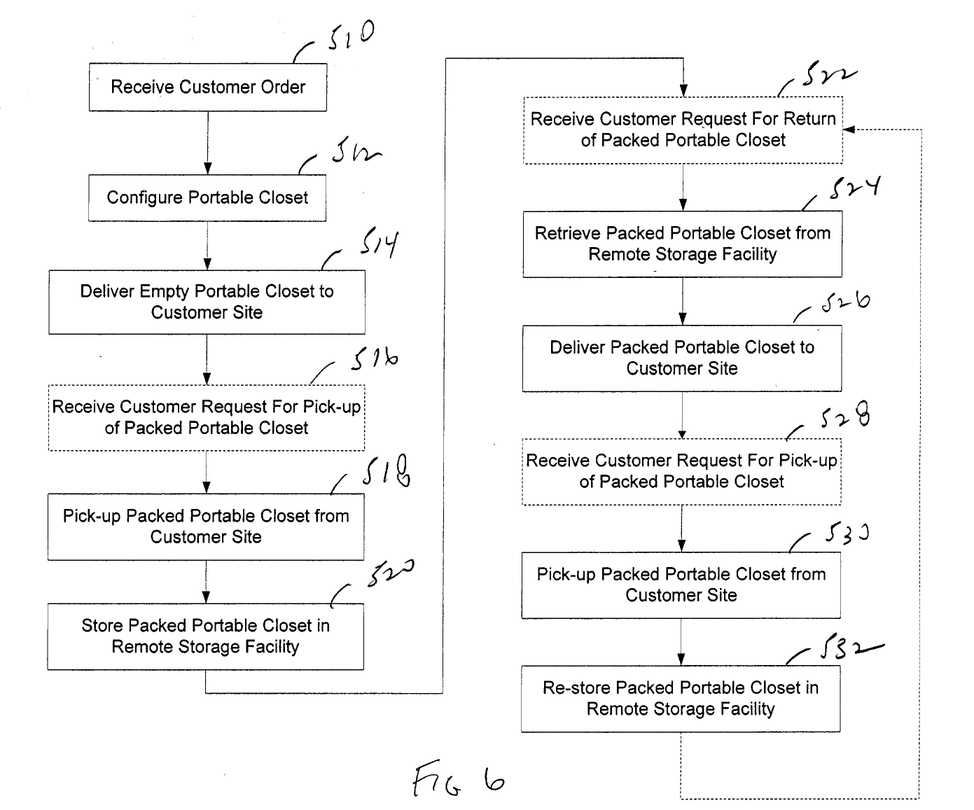

FIG. 6 is a flowchart of the process that is performed by the service provider in delivering, retrieving, and storing the portable closet of one embodiment of the present invention. At step 510, the server 20 at the service provider receives the customer's order from, e.g., PC 10. At step 512, the service provider configures one or more empty portable closets to the customer's configuration selections (see FIG. 3). The empty portable closet(s) is then delivered to the customer's site (step 514).

In one embodiment, the customer's empty portable closet has been loaded on a truck with empty and packed portable closets for other customers. The portable closets on the truck may be similar in that the customers that they are to be delivered to all live in a specified area or route. The service provider then drives to the customer's location, e.g., an apartment building, and unloads the portable closet. The portable closet may be wheeled into an elevator. From the elevator the portable closet is then wheeled into the customer's apartment via the customer's apartment door entrance and left for the customer to pack. One of the significant advantages of this and other embodiments of the present invention is that by letting the customer pack the portable closet him or herself, there is a significant reduction in labor costs. Hence there is a significant reduction in the overall cost of storage, while maintaining the convenience of delivery and pick-up of the storage from a customer's home (or office).

In addition, the portable closet may be used by the customer as an additional closet in the home (or office). For example, near the end of winter, the winter clothes may be hung in the portable closet rather than a normal closet. At the end of winter, the portable closet containing the winter clothes is sent off to storage, until next winter.

At step 516, the service provider receives from the customer a request (where the request may have been scheduled in advance) for pickup of the packed portable closet. At step 518, the service provider picks up the packed portable closet from the customer's site, e.g., inside a customer's apartment or office. At step 520, the service provider stores the packed portable closet in the service provider's remote storage facility. At step 522, the service provider receives the customer's request for return of the packed portable closet, where again the request may be scheduled in advance. The packed portable closet is retrieved from the remote storage facility (step 524) using, for example, a label on the portable closet having an identifier such as a closet number. The packed portable closet is delivered to the customer's site (step 526). At step 528, the service provider receives a request for pickup of the repacked portable closet, i.e., the contents of the portable closet have been modified, and at step 540, picks up the packed portable closet from the customer's site. The packed portable closet is then re-stored in the remote storage facility (step 532). Steps 522 to 532 are then repeated so that the potable closet is shuttled back and forth between storage facility and customer site. Steps 522 to 532 on the service provider side correspond to steps 122 to 130 of FIG. 2 on the customer side.

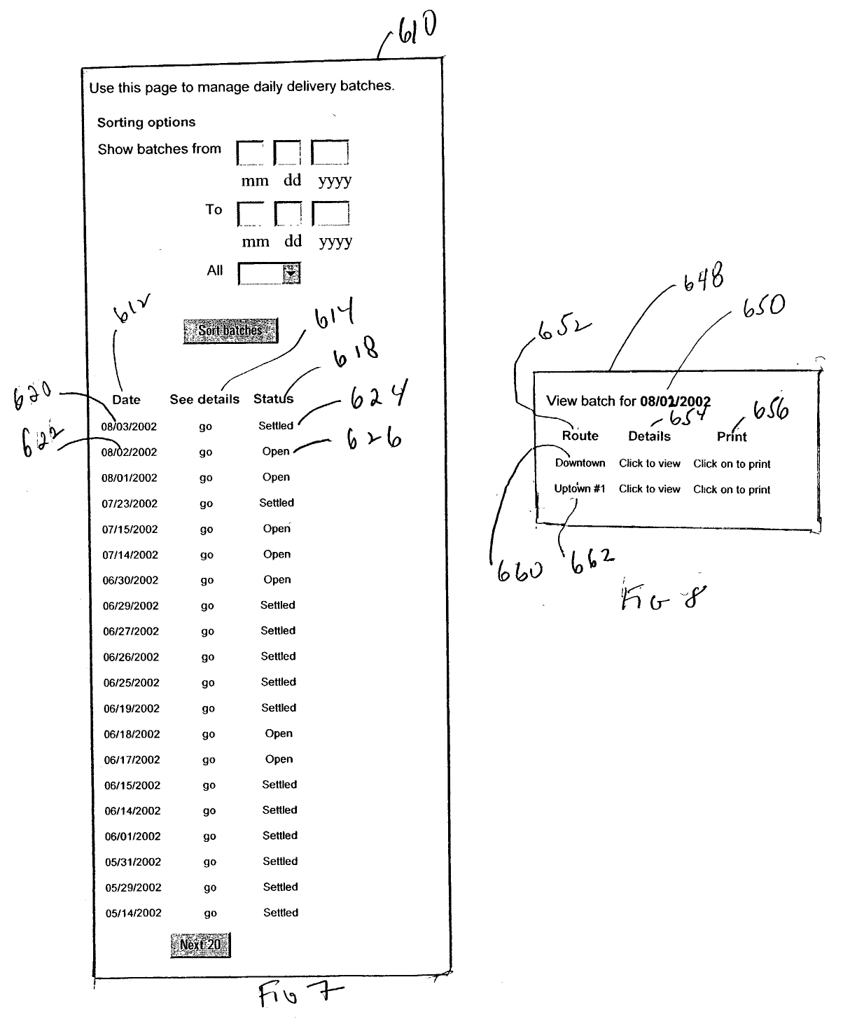

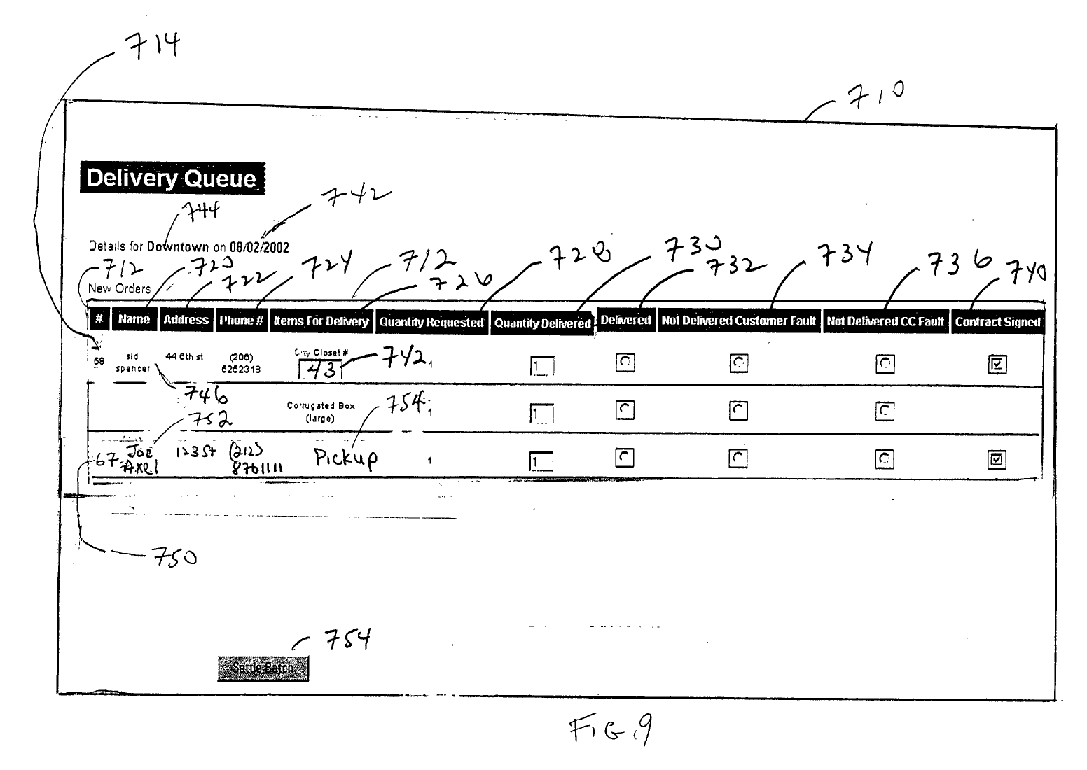

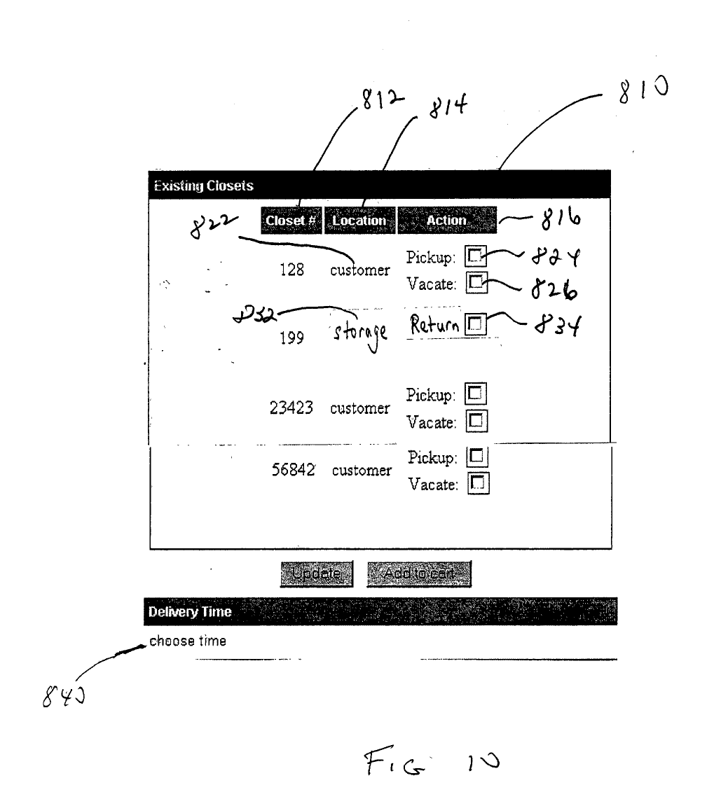

FIG. 7 is an example of a window 610 of the daily deliveries (and/or pick-ups) of portable closets to (or from) customers. There are three columns shown: a date column 612, a “see details” column 614, and a status column 618. The date column gives the calendar date of any scheduled and/or actual deliveries (and/or pick-ups) of portable closets to customers on that calendar date, e.g., date 620 (08/03/2002) and date 622 (08/02/2002). The “go” hyperlink in the see details column 614 brings up a batch window 648 (FIG. 8) for a selected date in date column 612. The status of the deliveries (and/or pick-ups) for a particular date is either “open,” i.e., there are outstanding selections in FIG. 9 that need to be selected, or “settled,” i.e., whether the items to be delivered (or picked-up) that day where delivered (or picked-up) or not, and if not whose fault was it for the non-delivery (or non-picked-up).

FIG. 8 is an example of a window 648 showing the route categories for the deliveries (and/or pick-ups) for a particular date. The date 650 (08/02/2002) is that selected in FIG. 7, e.g., date 622 (08/02/2002). The columns include route column 652, a details column 654 having hyperlinks to a delivery (and/or pick-up) queue (FIG. 9), and a print column 656 for printing a delivery (and/or pick-up) queue. The scheduled and actual deliveries (and/or pick-ups) for the date 650 (08/02/2002) are sorted by route 652, e.g., the area of the city. For the example of New York City, the deliveries (and/or pickups) for the date 650 include downtown 660 and uptown #1 662. Selecting “Click to view” for Downtown 660 brings up a delivery (and/or pick-up) queue window 710 (FIG. 9) for the date 650.

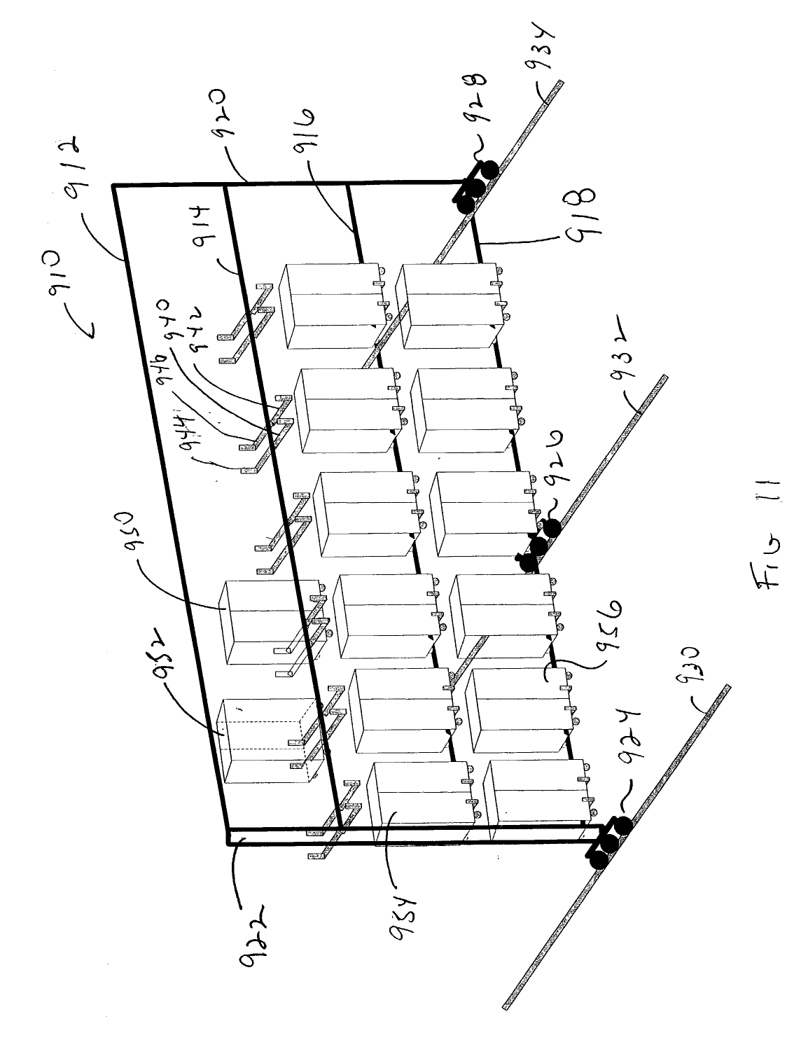

FIG. 9 is an example of a delivery (and/or pick-up) queue window 710 allowing for the input of the status of the delivery (and/or pick-up) of the portable closets to the customers for a given date 742. There are several columns displayed, including the order number 712, the name of the customer 720, the customer's address 722, the customer's phone number 724, items for delivery (or pick-up) 726, the number of each item requested for delivery (or pick-up) 728, the quantity delivered (or picked-up) 730, whether there was an actual delivery (or pick-up) 732, if there was no delivery (or pick-up) then if it was the customer's fault 734 or the service providers fault 736, and if a contract was signed 740 between the service provider and the customer. A portable closet is identified by its closet number, e.g., 43 (in entry box 742). In one embodiment the closet number 43 associated with “Sid Spencer” 746 is looked up in another table. In an alternative embodiment the closet number 43 is automatically filled in by server 20. An example, of a pick-up of a portable closet in the delivery queue is given by 750, i.e., new order #67. The customer name 720 is Joe Axel 752 and the “Pickup” 754 in the “Items for Delivery” column 726, indicates that the portable closet(s) at the customer's site needs to be picked up by the service provider. What the closet number(s) is to be picked up is determined from FIG. 10.

Once the appropriate selections are made by a person at a computer in the operations section 24, the “Settle Batch” button 754 is pushed. The status column 618 in FIG. 7 goes from “open” to “settled” and the selections in window 710 become fixed. For example, selecting date 620 (08/03/2002) displays a window with columns headings similar to FIG. 9, however, the data displayed may be only viewed but not changed (i.e., read-only).

FIG. 10 is an example of a window 810 for selecting what action is to be performed on existing customer's portable closets by the service provider. The window 810 is for a particular customer (not shown) and is for existing, not newly ordered empty portable closets. The columns in window 810 include: the closet number 812, the physical location of the portable closet 814 (either at the customer's site or stored in the remote storage facility), and an action 816 (pickup or vacate or return). An example is for portable closet #128, where the location 814 of the portable closet is at the “customer” 822, i.e., customer's site. An action 816 needs to be selected. A pick-up 824 is a retrieval of a packed portable closet from the customer for storage in the remote storage facility. A vacate 826 is a retrieval of a portable closet from the customer because, for example, the customer does not need the portable closet anymore. Another example is for portable closet #199, where the location 814 of the portable closet is “storage” 822, i.e., stored in the remote storage facility.” The action “Return” 834 is selected to retrieve the portable closet #199 from the remote storage facility and return the portable closet to the customer's site. If a closet # for delivery is given in FIG. 9 and is not listed in FIG. 10 then the portable closet is an empty, new closet not an existing closet.

From FIGS. 9 and 10 there can be a delivery of an empty, new portable closet (corresponding to delivery time 320 in FIG. 4), a delivery of a packed portable closet (corresponding to home return time 324 in FIG. 4), or a pick-up of a packed (or empty) portable closet (corresponding to pick-up time 322 in FIG. 4). In one embodiment FIG. 10 is filled in manually (including selecting the delivery times, i.e., selecting “choose time” 840 which is hyperlink to the calendar of FIG. 5) at the operations section 24. In another embodiment FIG. 10 is filled in automatically after the customer selects a delivery/pickup/home return date and time in FIG. 4 and FIG. 5.

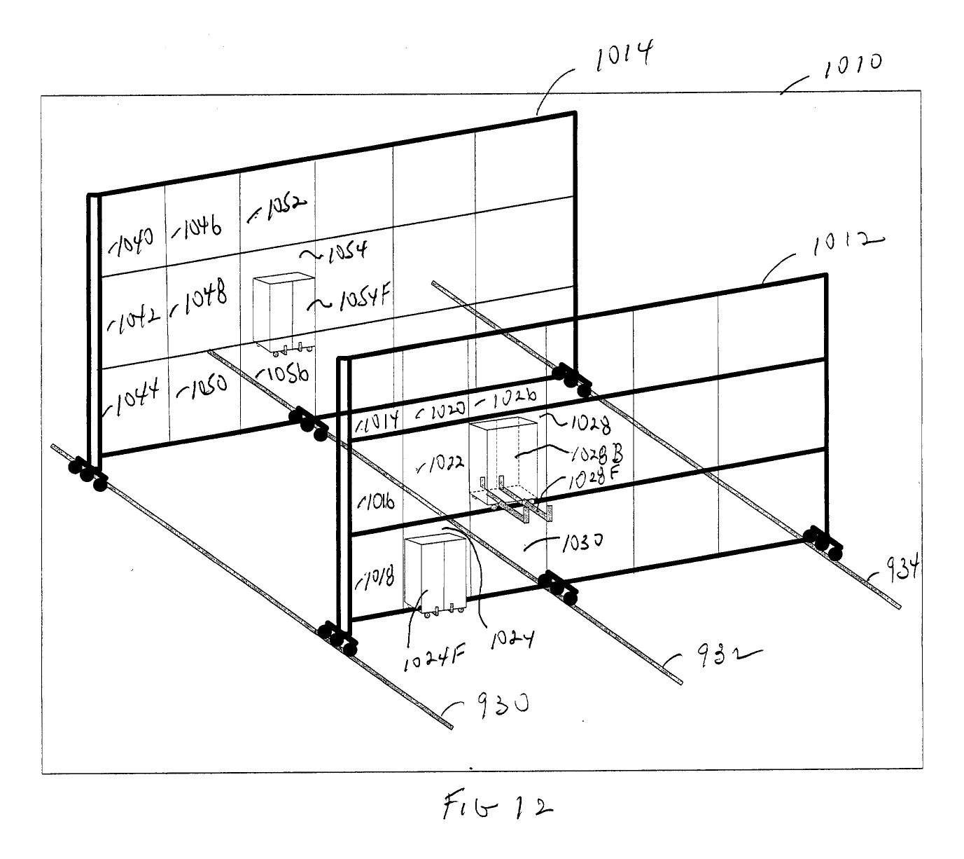

FIG. 11 is a framework 910 mounted on tracks for holding a plurality of portable closets of one embodiment of the present invention. FIG. 11 is illustrative and not drawn to scale. The framework 910 includes two parallel vertical supports 920 and 922 and four parallel horizontal supports 912, 914, 916, and 918. Each vertical support is attached to railway car type wheels, which roll on top of a rail, e.g., wheels 924, and 928 on top of rails 930 and 934, respectively. In addition there are center wheels 926 attached to the middle of horizontal support 918 and mounted on rail 932. The rails are parallel to each other and movement of the framework 910 is along the rails. And alternative embodiment has wheel ruts in the place of rails 930, 932 and 934.

A plurality of portable closets, e.g., 950, 952, 954, and 956, are stored and held by the horizontal supports 914, 916, and 918. Each horizontal support has a plurality of “L” shaped arms, where the L-shaped arms are attached to and perpendicular to the horizontal support. For example, horizontal support 914 has L-shaped arms 940 942, 944, and 946. L-shaped arms 940 and 942 support one portable closet on one side of the framework 910, for example, as shown by portable closet 950. The L-shaped arms 940 and 942 are positioned far enough apart to allow for the forks of a forklift to get between the L-shaped arms 940 and 942 in order to lift the portable closet onto and off of the L-shaped arms 940 and 942. L-shaped arms 944 and 946 support one portable closet on the other side of the framework 910, for example, as shown by portable closet 952.

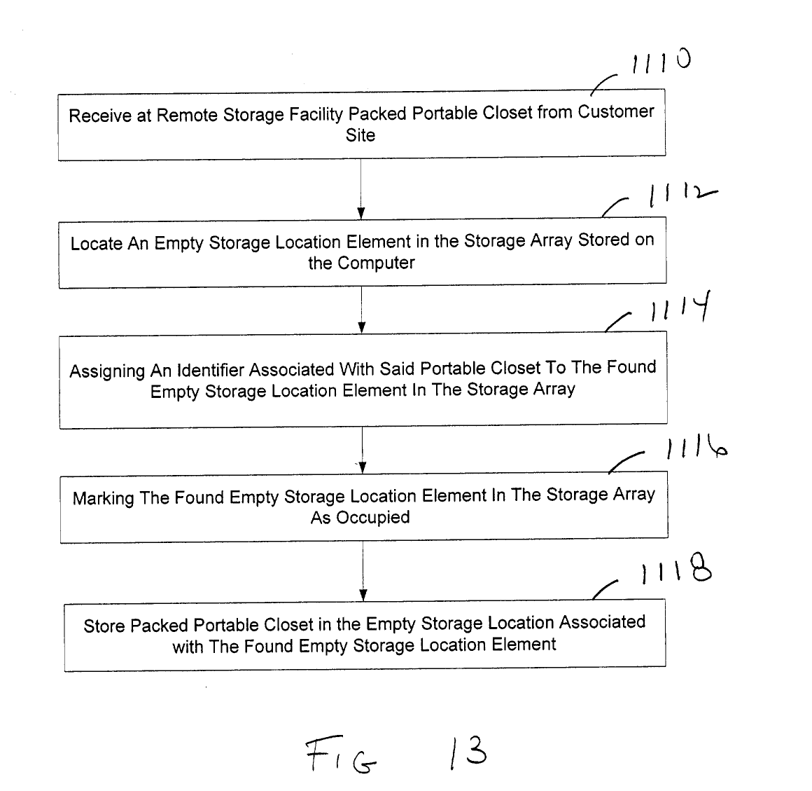

FIG. 12 shows a plurality of frameworks like FIG. 11 of an embodiment of the present invention. FIG. 12 is illustrative and not drawn to scale. There are two frameworks shown, 1012 and 1014, where each framework is of similar structure to framework 910 of FIG. 11. The first framework 1012 stores multiple portable storage closets in multiple storage slots on both sides of the framework. If the framework 1012 is treated like a plane, then there is two dimensional (2-D) matrix formed on the plane. The 2-D matrix has multiple elements, for example, 1014, 1016, 1018, 1020, 1022, 1024, 1026, 1028, and 1030, with each element having two storage locations, one on each side of framework 1012. For example element 1024 has storage location 1024F (front) which has is occupied by a storage closet and opposite location 1024B (back) which is empty. Another example is 2-D matrix element 1028 which has storage location 1028B occupied by a storage closet and opposite location 1028F which is empty. Similarly second framework 1014 stores multiple portable storage closets in multiple storage slots on both sides of the framework and can also be represented by a 2-D matrix with elements, e.g., 1048, 1050, 1052, 1054, and 1056 where each element may hold a storage closet on each side of the framework 1014. For example element 1054 has a storage location 1054F occupied by a portable closet.

As each framework has a 2D matrix with a front and back storage location for each element of the matrix, and as there are one of more frameworks, the multiple 2D matrices form a three dimensional matrix (3D) of storage locations. Each cell of the 3D matrix is a potential or actual storage location for a portable closet. This 3D matrix is represented in a computer memory of server 20 by a 3D array, where the address of each element of the array corresponds to the storage location in the 3D matrix. And the contents of each 3D array element includes, e.g., whether the storage location is empty or occupied, and if occupied, the portable closet identifier. A graphical image similar to that shown in FIG. 12 can be displayed on a computer display in operations 24 of FIG. 1 to represent and perform operations on the 3D array.

FIG. 12 shows that frameworks 1012 and 1014 maybe moved along the tracks 930, 932 and 934 in an accordion type fashion to both minimize storage space in the remote storage facility and to allow access for a forklift to store or retrieve a portable closet. For example, framework 1012 can be moved toward framework 1014 until the distance between the frameworks is about two portable closets apart. When a portable closet, such as portable closet at location 1054F, needs to be removed, framework 1012 can be moved away from framework 1014, so that a forklift can get in between the two frameworks to remove the portable closet at location 1054F. The number of frameworks and storage locations shown in FIG. 12 are for illustration purposes only and was kept small so as not to obscure the invention.

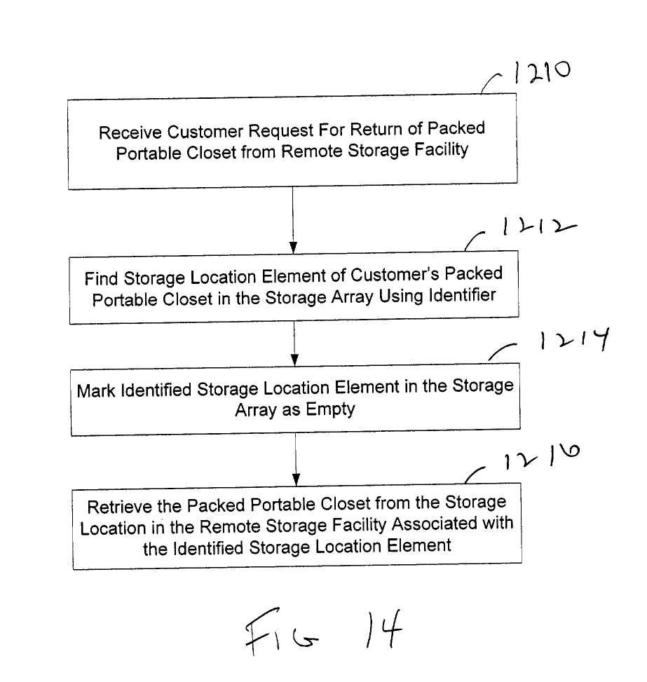

FIG. 13 is a flowchart of the process of storing a portable closet in the remote storage facility of an embodiment of the present invention. At step 1110 the self-packed portable closet from the customer's site is received at the storage facility. At step 1112 using server 20, finding an element in the 3-D array, stored in a memory, that is marked empty, i.e., an empty storage location element. An identifier associated with the portable closet, e.g., the closet number, is assigned to the found empty storage location element in the storage array. At step 1116 the found empty storage location element in the storage array is marked as occupied. The packed portable closet is then stored in the empty storage location associated with the found empty storage location element (step 1118).

FIG. 14 is a flowchart of the process for retrieving the portable closet from the remote storage facility. At step 1210 the customer request is received for return of the packed portable closet. At step 1212 the storage location element of the customer's portable closet is found by a search of the storage array by server 20 using the identifier, such as a closet number or a customer name. At step 1214 the storage location element in the storage array is marked as empty. And at step 1216 the portable closet is retrieved from the storage location associated with the found storage location element, and delivered to the customer.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the invention has been described using a particular series of transactions and steps, it should be apparent to those skilled in the art that the scope of the invention is not limited to the described series of transactions and steps.

Further, while the invention has been described using a particular combination of hardware and software, it should be recognized that other combinations of hardware and software are also within the scope of the invention. The invention may be implemented only in hardware or only in software or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A method for storing by a service provider, in a remote storage facility, a portable closet, comprising a plurality of items of a customer, said method comprising:
said service provider delivering an empty portable closet configured to fit through a standard doorway entrance to a customer's site, wherein said portable closet is non-collapsible and comprises a plurality of wheels attached to said portable closet;
said service provider retrieving for storage a packed portable closet from said customer's site, wherein said packed portable closet is said empty portable closet packed by said customer with said plurality of items; and
storing said first packed portable closet in said remote storage facility.

2. The method of claim 1 further comprising:
wherein responsive to said customer requesting access to said packed portable closet, said service provider delivering from said remote storage facility said packed portable closet to inside said customer's site; and
said service provider retrieving for storage said packed portable closet having at least one of said plurality of items removed by said customer.

3. The method of claim 1 further comprising:
wherein responsive to said customer requesting express access to said packed portable closet, said service provider delivering from said remote storage facility said packed portable closet to inside said customer's site within a predetermined expedited time period.

4. The method of claim 1 wherein said standard doorway entrance has dimensions of a doorway entrance to an apartment in a multi-story building.

5. The method of claim 1 wherein said empty portable closet has exterior dimensions of about 6 feet high, about 4 feet wide, and about 28 inches deep.

6. The method of claim 1 wherein said empty portable closet has an interior cedar lining for preservation of any garments stored therein.

7. The method of claim 1 wherein said delivering an empty portable closet comprises using an apartment elevator.

8. A method for storing by a service provider, in a remote storage facility, a portable container, comprising a plurality of items of a customer, said method comprising:
said service provider delivering an empty portable container configured to fit through a standard doorway entrance of a customer's site, said portable container comprising wheels for portability and non-collapsible walls;
said service provider retrieving for storage a packed portable container from said customer's site, wherein said packed portable container is said empty portable container packed by said customer with said plurality of items;
storing said packed portable container in a remote storage facility;
responsive to said customer requesting access to said packed portable container, said service provider delivering from said remote storage facility said packed portable container to said customer's site; and
said service provider retrieving for storage said packed portable container having at least one of said plurality of items removed by said customer.

9. The method of claim 8 wherein said empty portable closet has exterior dimensions of about 6 feet high, about 4 feet wide, and about 28 inches deep.

10. The method of claim 8 wherein said empty portable closet has an interior lining.

11. The method of claim 10 wherein said interior lining comprises cedar.

12. A method for storing a plurality of items of a customer in a portable closet, said customer at a first computer placing an order related to said portable closet to a service provider at a second computer via a communications network, said method comprising:
configuring an empty portable closet by said first computer;
scheduling deliver of said configured empty portable closet to inside a customer's site using a standard doorway entrance; and
scheduling retrieval for storage of a packed portable closet from inside said customer's site, wherein said packed portable closet is said configured empty portable closet packed by said customer with said plurality of items.

13. The method of claim 12 wherein said second computer comprises a Web site for receiving said order.

14. The system of claim 12 wherein said configured empty portable closet comprises at least one clothes hanger bar.

15. The method of claim 12 wherein said order comprises a quantity of portable storage closets and a predetermined minimum number of return deliveries, said predetermined number dependent on said quantity.

16. The method of claim 15 wherein each portable storage closet ordered has a fixed number of free return delivery credits, wherein said predetermined minimum number comprises a sum of said fixed number, and wherein said sum is used with at least one of said portable storage closets.

17. A method for storing a portable closet by a service provider in a remote storage facility, using a computer system, said method comprising:
said computer receiving an order by said customer for said portable closet, said order comprising configuration information, said portable closet comprising a clothes hanger bar, wheels, and non-collapsible walls;
assigning an identifier associated with said portable closet;
labeling said portable closet with at least said identifier;
responsive to a request for delivery of said portable closet to said customer's premises, sending graphical information for a deliver calendar comprising available and unavailable times for delivery of said portable closet;
after said customer selects an available time for delivery from said deliver calendar, adding said identifier to a delivery queue, said delivery queue stored in memory;
delivering said portable closet to said customer's premises; and
responsive to a request for pickup of said portable closet, retrieving and storing said portable closet in said remote storage facility.

18. The method of claim 17 wherein said configuration information comprises a position of at least one clothes hanger bar or a position of at least one shelve or a combination thereof.

19. The method of claim 17 wherein said identifier is associated with said customer's name.

20. A method, using a computer, for storing by a service provider, in a remote storage facility, a plurality of portable closets, a portable closet of said plurality of portable closets comprising an item of a customer, said method comprising:
receiving said portable closet at said remote storage facility;
finding an empty storage location element in a storage array, said storage array, comprising a three dimensional array having elements for empty and occupied storage locations in said remote storage facility for said plurality of portable closets, said elements stored in a memory of said computer;
assigning an identifier associated with said portable closet to said found empty storage location element in said storage array; and
storing said portable closet in a storage location associated with said found empty storage location element.

21. The method of claim 20 further comprising marking said found empty storage location element in said storage array as occupied.

22. The method of claim 21 further comprising:
responsive to a customer request to access said stored portable closet, using said identifier, finding said found empty storage location element in said storage array;
marking said found empty storage location element in said storage array as empty; and
retrieving said stored portable closet from said storage location associated with said found empty storage location element.

23. A system for storing a plurality of portable closets in a storage facility comprising:
a plurality of structures, each structure of said plurality of structures positioned generally perpendicular to the floor of said storage facility and parallel to at least one other structure of said plurality of structures;
a track in said storage facility for moving said plurality of structures, wherein each structure of said plurality of structures is mounted on said track via at least one wheel; and
a plurality of storage locations in each structure of said plurality of structures, wherein a storage location of said plurality of storage locations holds a portable storage closet of said plurality of portable closets.

24. The system of claim 23 wherein said structure of said plurality of structures comprises a parallelogram shaped framework.

25. The system of claim 24 wherein said parallelogram shaped framework comprises a longitudinal element for supporting said portable storage closet when stored.

26. The system of claim 25 wherein said longitudinal element has a plurality of L shaped members, for holding said portable storage closet, attached to and perpendicular to said longitudinal element.
